(19) United States
(12) Patent Application Publication
(10) Pub. No.: US 2015/0061581 A1
(43) Pub. Date: Mar. 5, 2015

(54) INDUCTIVELY CHARGEABLE BATTERIES

(71) Applicant: POWERMAT TECHNOLOGIES LTD., Neve Ilan (IL)

(72) Inventors: Amir Ben-Shalom, Modiin (IL); Arik Rofe, Jerusalem (IL); Oola Greenwald, Mevasseret Zion (IL); Elieser Mach, Rosh Tzurim (IL); Guy Raveh, Mataa (IL)

(21) Appl. No.: 14/385,654

(22) PCT Filed: Mar. 12, 2013
(86) PCT No.: PCT/IL2013/050227

§ 371 Date: Sep. 16, 2014

Related U.S. Application Data
(60) Provisional application No. 61/611,966, filed on Mar. 16, 2012.

(51) Int. Cl. H02J 7/02; H02J 7/00

(52) U.S. Cl. CPC H02J 7/025; H02J 7/0068; H02J 7/007
USPC 320/108; 320/134

(57) ABSTRACT

An inductive power transfer system for charging batteries may include an inductive power transmitter, an inductive power receiver and an electrochemical cell or battery. The inductive power receiver may include a secondary inductor incorporated in enabled batteries or battery packaging, which when inductively coupled to a primary inductor of an inductive transmitter is operable to supply a potential across the electrochemical cell or battery thereby enabling the cell or battery to be charged or maintained at a charged level. The inductive battery may be in the shape of an industry standard battery.

### FIELD OF THE DISCLOSURE

The embodiments disclosed herein relate to inductive power transfer systems. In particular the embodiments relate to inductive power transfer systems operable to transfer power to an inductively chargeable battery.

### BACKGROUND

Inductive power coupling, as known in the art, allows energy to be transferred from a power supply to an electric load without connecting wires. A power supply is wired to a primary coil and an oscillating electric potential is applied across the primary coil, thereby inducing an oscillating magnetic field. The oscillating magnetic field may induce an oscillating electrical current in a secondary coil placed close to the primary coil. In this way, electrical energy may be transmitted from the primary coil to the secondary coil by electromagnetic induction without the two coils being conductively connected. When electrical energy is transferred from a primary coil to a secondary coil the coil pair are said to be inductively coupled. An electric load wired in series with such a secondary coil may draw energy from the power source wired to the primary coil when the secondary coil is inductively coupled thereto.

Induction type power outlets may be preferred to the more common conductive power sockets because they provide seamless power transmission and minimize the need for trailing wires.

The range of the inductive transmission as well as the strength of the induced voltage in the secondary inductor both vary according to the oscillating frequency of the electrical potential provided to the primary inductor. The induced voltage is strongest when the oscillating frequency equals the resonant frequency of the system. Efficiency of energy transfer depends upon a number of parameters including the resonant frequency of the system, the transmission frequency of operation as well as the distance and alignment between the primary and secondary inductive coils. There is a need for an inductive power transmission system that is compatible with existing electrochemical batteries. The embodiments described herein address this need.

### SUMMARY OF THE EMBODIMENTS

In a first aspect of the disclosure, the embodiments described herein disclose an inductive power transfer system comprising at least one of an inductive power transmitter and an inductive battery. The inductive power transmitter may comprise at least one primary inductor configured to couple inductively with at least one secondary inductor and at least one driver configured to provide a variable electric potential at a driving frequency across said primary inductor. The inductive battery may comprise at least one secondary inductor connectable to a receiving circuit and an electric load, said secondary inductor configured to couple inductively with said at least one primary inductor such that power is transferred to said electric load. Further, the inductive battery may be in the shape of an industry standard battery.

In certain embodiments of the disclosure, the electric load may be a battery comprising a plurality of electrochemical cells. The electrochemical cell may be selected from the group consisting of a lithium-thionyl chloride cell, a Li/SOCl2 Cell, a Li/SO2 Cell, a Li/MnO2 Cell, a Lithium Polymber Cell, a Special Cell, a Mobile Phone Cell, a Charger Li-ion Cell, a NiMH Cells and a New Products NiCd Cells.

In certain embodiments of the disclosure, the inductive power receiver may be in a shape that is substantially the same as, and compatible with connection mechanisms for, a battery shape selected from the group consisting of AAA, U16, Micro, Microlight, MN2400, MX2400, Type 286, UM 4, #7, 6135-99-117-3143, AA, U7, Pencil sized, Penlight, Mignon, MN1500, MX1500, Type 316, UM3, #5, 6135-99-052-0009, 6135-99-195-6708, C, U11, MN1400, MX1400, Baby, Type 343, BA-42, UM2, #2, 6135-99-199-4779, 6135-99-117-3212, D, U2, Flashlight Battery, MN1300, MX1300, Mono, Type 373, BA-30, UM1, #1, 6135-9-464-1938, 6135-99-109-9428, 9-Volt, PP3, Radio Battery, Smoke Alarm, MN1604, Square Battery, Krona, Transistor, 6135-99-634-8080, Watch Cell, Button Cell, Coin Cell, Micro Cell and Miniature Cell.

In certain embodiments of the disclosure, the electric load may be shielded.

In certain embodiments of the disclosure, the receiving circuit comprises a resonance tuner. The resonance tuner may be operable to tune the resonant frequency of said receiving circuit to a plurality of target frequencies, wherein a target frequency is determined by an operational mode. The operational mode may be determined by a mode selector. The mode selector may be manually activated or automatically be activated.

Optionally, at least one of said target frequencies is the driving frequency of the primary inductor.

Optionally, at least one of said target frequencies is a frequency that is substantially different from the driving frequency of the primary inductor. Optionally, the driving frequency is 50-90% of the resonant frequency. Alternatively, the driving frequency is 110-160% of the resonant frequency.

In certain embodiments of the disclosure, the receiving circuit may comprise a resonance seeking arrangement operable to determine the natural resonant frequencies of the inductive power transfer system.

In certain embodiments of the disclosure, the receiving circuit may comprise a regulator operable to trickle charge the electric load.

Optionally, the regulator is configured to provide a current to the electric load such that the rate of charging the electric load is substantially the same as the self-discharging rate of the electric load.

Optionally, the regulator is operable to monitor the discharge voltage of the electric load, and wherein the regulator comprises a switching unit operable to disconnect the electric load from the induced output voltage from the secondary inductor if the discharge voltage of the electric load is at a reference level signifying full charge, and further operable to connect the electric load to the induced output voltage from the secondary inductor if the discharge voltage of the electric load is below the reference level signifying full charge.

In certain embodiments of the disclosure, the inductive power transmitter may be a battery case. The inductive power transmitter may provide at least one fitted compartment, each compartment capable of containing at least one inductive battery such that the inductive battery is immobilized in a position wherein the primary inductor and the secondary inductor are aligned.

Optionally, the inductive power transmitter provides a plurality of fitted compartments, each compartment capable of containing one inductive battery.

Optionally, the fitted compartment is configured to contain a plurality of inductive batteries.

In certain embodiments of the disclosure, the power transfer system may comprise a rotational alignment mechanism configured to prevent rotational movement of the inductive battery.

Optionally, the rotational alignment mechanism comprises a magnetic anchor situated in the inductive power transmitter and a magnetic snag situated in the inductive battery.

Optionally, the rotational alignment mechanism comprises a wedge situated on the inductive power transmitter and a groove situated on the inductive battery.

In certain embodiments of the disclosure, an inductive power transmitters is configured to be electrically connectable to at least one other inductive power transmitter such that the plurality of electrically connected inductive power transmitters is connectable to a single power source.

Optionally, the inductive power transmitter is configured to electrically connect with another inductive power transmitter when the first inductive power transmitter is stacked on the second inductive power transmitter.

In a second aspect of the disclosure, the embodiments described herein disclose a method of charging inductive batteries. The method comprises the steps of: (a) providing at least two inductive power transmitters, each inductive power transmitter comprising at least one primary inductor configured to couple inductively with at least one secondary inductor and at least one driver configured to provide a variable electric potential at a driving frequency across said primary inductor, and containing at least one an inductive battery comprising at least one secondary inductor connectable to a receiving circuit and an electric load, said secondary inductor configured to couple inductively with said at least one primary inductor such that power is transferred to said electric load; (b) stacking said inductive power transmitters such that the inductive power transmitters are electrically connected; and (c) connecting the stack of inductive power transmitters to a power source.

In certain embodiments of the disclosure, the power source may be contained within a storage device.

In certain embodiments of the disclosure, the inductive power transmitter and the inductive battery may be configured to trickle charge the electric load.

In certain embodiments of the disclosure, the receiving circuit comprises a regulator configured to provide a current to the electric load such that the rate of charging the electric load is substantially the same as the self-discharging rate of the load.

In certain embodiments of the disclosure, the regulator may be operable to monitor the discharge voltage of the electric load. Further, the regulator may comprise a switching unit operable to disconnect the electric load from the induced output voltage from the secondary inductor if the discharge voltage of the electric load is at a reference level signifying full charge, and further operable to connect the electric load to the induced output voltage from the secondary inductor if the discharge voltage of the electric load is below the reference level signifying full charge.

In a further aspect of the disclosure a system is introduced for charging batteries in storage. A battery packaging may be provided comprising a secondary inductor operable to inductive couple with a primary couple, the secondary inductor being wired to a pair of conductive contacts configured to conductively couple with at least one anode and at least one cathode of at least one electrochemical cell stored within said battery packaging. The battery packaging may further comprise a charging circuit operable to control charging of the at least one electrochemical cell. The charging circuit may comprise a regulator, a rectifier, a temperature monitor, a charge monitor and the like.

### BRIEF DESCRIPTION OF THE FIGURES

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the several selected embodiments may be put into practice. In the accompanying drawings:

FIG. 1 is a block diagram showing selected elements of an inductive power transfer system operable to provide power inductively from an inductive power transmitter to an inductive battery.

FIGS. 2A-2D are schematic representations of illustrative examples showing possible configurations for the location and orientation of a secondary inductor as a part of an inductive battery.

FIG. 3 is a schematic representation of one illustrative example of an inductive power transmitter having a single primary inductor for charging multiple inductive batteries.

FIG. 4 is a schematic representation of another illustrative example of an inductive power transmitter incorporating multiple primary inductors.

FIG. 5 is a schematic representation of another illustrative example of an inductive power transmitter having a single primary inductor for charging multiple inductive batteries.

FIG. 6 is a schematic representation of an illustrative example of an inductive power transmitter having multiple primary inductors.

FIGS. 7A-7C are schematic representations of illustrative examples of alignment mechanisms incorporated into the inductive power transmitter that may orientate the inductive batteries and limit their movement inside.

FIGS. 8A-8B are schematic representation of illustrative examples of alignment mechanisms incorporated into the inductive power transmitter and the inductive battery that may limit rotational movement of the inductive battery.

FIG. 9 is a schematic representation of multiple inductive power transmitters stacked and electrically connected so as to receive power from a common power source.

FIG. 10 is a flowchart of a method for determining the operation mode of the power transfer system.

### DESCRIPTION OF THE SELECTED EMBODIMENTS

Inductive Power Transfer System with Inductive Battery

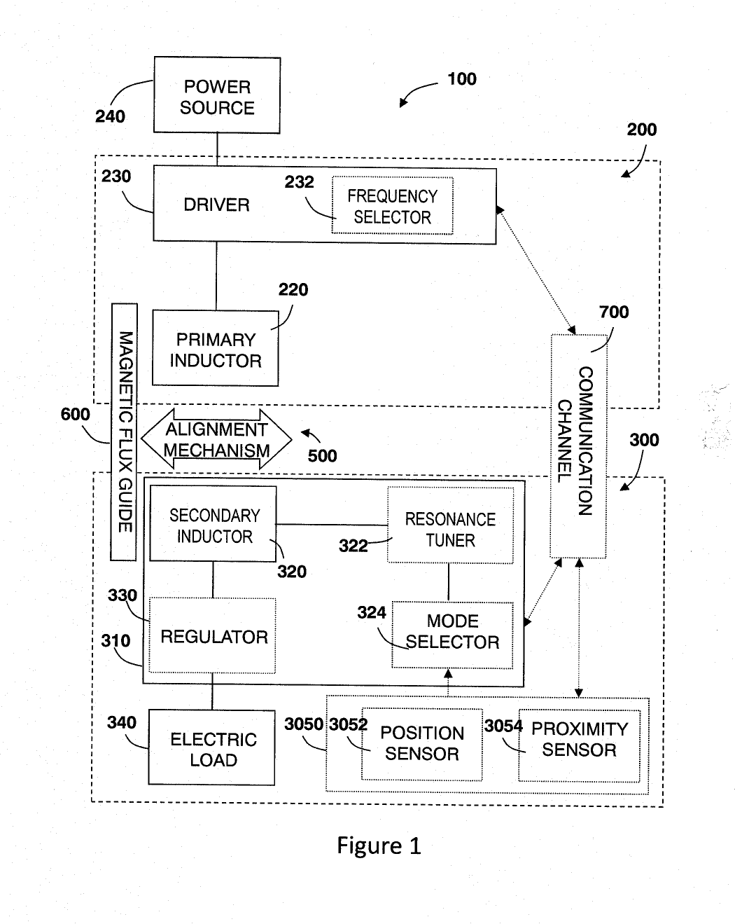

Reference is now made to FIG. 1, which shows a block diagram showing various elements of an inductive power transfer system 100 operable to provide power inductively from an inductive power transmitter 200 to an inductive battery 300.

The inductive power transmitter 200 includes a primary inductor 220 and a driver 230. The inductive power transmitter 200 may be connected to a power source 240 such as a mains electricity socket, a transformer, a power pack, solar panel or the like. The driver 230 is operable to provide a variable electric potential across the primary inductor 220 at a selected driving frequency thereby producing an oscillating magnetic field that may be used to induce an electric potential in a secondary inductor 320 of an inductive battery 300.

The inductive battery 300 includes a secondary inductor 320, which may be wired to an electric load 340 via a reception circuit 310. The secondary inductor 320 is configured to generate an oscillating induced voltage when placed inside the oscillating magnetic field produced by a primary inductor 220. The reception circuit 310 may include a regulator 330 provided to regulate the output voltage into a form suitable for the electric load 340. According to various systems, the regulator 330 may include rectification circuits, voltage control circuits, current control circuits or the like. The inductive power receiver 300 may further include a resonance tuner 322 which may be used to adjust the resonant frequency of the reception circuit 310 to suit requirements. The electric load 340 may be an electrochemical cell, a battery or a supercapacitor (alternatively electric double-layer capacitor (EDLC), supercondenser, electrochemical double layer capacitor, or ultracapacitor).

The power reception range over which the inductive battery 300 may receive power from the inductive power transmitter 200 may depend upon a number of factors including the strength and extension of the oscillating magnetic field, the size and position of the primary inductor, the frequency of power transfer, the resonant frequency of the reception circuit 310, the efficiency of power transfer and the like.

### Communication Channel

The inductive power transmission system 100 may further include a communication channel 700 and an alignment mechanism 500. The communication channel 700 is provided to allow communication between the inductive power receiver 300 and the inductive power transmitter 200. Data may be passed between the inductive power receiver 300 and the inductive power transmitter 200 pertaining to their relative positions, identification, operational parameters such as required operating voltage, current, temperature or power for the electric load 340, the measured voltage, current, temperature or power supplied to the electric load 340 during operation, the measured voltage, current, temperature or power received by the electric load 340 during operation, and the like. Furthermore, the communication channel 700 may be used to communicate feedback signals from the receiver 300 to the transmitter 200 for example instructions communicated to the driver 230 to adjust operating parameters such as driving voltage amplitude, driving current, duty cycle, operating frequency, operating mode or the like.

Various communication channels 700 may be used for the system such as a light emitting diode sending encoded optical signals, ultrasonic signals transmitted by piezoelectric elements or radio signals for example using known protocols such as Bluetooth, WiFi, Zigbee and the like. Alternatively or additionally, the primary and secondary inductors 220, 320 may themselves transfer communication signals via data-over-coil communication, for example using current and/or voltage modulation, frequency modulation, or the like.

### Alignment Mechanism

The alignment mechanism 500 is provided to enable the alignment between the primary inductor 220 and the secondary inductor 320. This may be of particular use when the inductive power transfer system 100 is operating in tightly coupled mode. Good alignment between primary inductor 220 and secondary inductor 320 may improve the efficiency of energy transfer and reduce electromagnetic radiation into the environment. Examples of alignment mechanisms are described below. Examples of alignment mechanisms may be found in the applicants copending U.S. patent application Ser. No. 12/524,987, which is incorporated herein by reference in its entirety.

### Magnetic Flux Guide

The alignment mechanism 500 may further include a magnetic flux guide 600. The magnetic flux guide 600 is provided to direct magnetic flux from the primary inductor 220 to the secondary inductor 320 and to reduce flux leakage to the surroundings particularly when operating in tightly coupled mode. The magnetic flux guide 600 may include a ferromagnetic core and a magnetic shield. The ferromagnetic core may be provided to guide magnetic flux from an active primary inductor to the secondary inductor.

For the purposes of illustration only, one such ferromagnetic core may be constructed, for example, from amorphous ferromagnetic material, possibly cut into wafers from a sheet approximately 20 microns thick or so. The ferromagnetic core may consist of two amorphous ferromagnetic wafers. A first wafer may be adhered to the primary inductor 220 and a second wafer may be adhered to the first wafer. The two wafers may then serve as a ferromagnetic core guiding magnetic flux from a primary inductor to the secondary inductor 320. Optionally the ferromagnetic wafers may have a radial slits to prevent the build-up of eddy currents within the wafer due to the oscillating magnetic field produced by the primary inductor 220. Where the wafer has a circular cross section, the slit may extend inwardly diametrically from the circumference.

The magnetic shield may be provided to prevent flux leakage into the surroundings. The magnetic shield may be fabricated from a sheet of thin amorphous ferromagnetic material and may be adhered to a printed circuit board by an adhesive insulating layer.

It will be appreciated that a magnetic shield is of particular importance when the inductive receiver 300 is mounted upon a conductive surface or a device containing conductive components. The magnetic shield may prevent magnetic flux from leaking into the conductive components and causing them to heat up.

Accordingly when the inductive power transfer system 100 is operating in tightly coupled mode, with the inductive power receiver 300 is aligned to the inductive power transmitter 200, the magnetic field lines are generally closed reducing possible magnetic radiation to the environment during operation.

### Modes of Operation

It is a particular feature of embodiments of the inductive power transfer system 100, described herein that it may be configured to operate in a plurality of modes such as tightly coupled mode, loosely coupled mode or the like as appropriate. Accordingly, a mode selector 324 may be provided to switch the inductive power transfer system between the various operational modes.

In tightly coupled mode, the relative positions of the primary inductor and secondary inductor are matched and they are inductively coupled at a high coefficient of coupling with a high efficiency of energy transfer. In one aspect of the tightly coupled configuration, the resonance frequency of the system 100 is adjusted to be different from the driving frequency of the voltage in the primary inductor 220. In a preferred embodiment, the resonance frequency of the system 100 is lower than the driving frequency of the voltage in the primary inductor 220. It is a particular feature of the tightly coupled mode that the driver 230 is configured and operable to transmit a driving voltage which oscillates at a transmission frequency which is substantially different from the resonant frequency of the system 100. The methods and compositions for (as well as the advantages of) having the driving voltage in the primary inductor be substantially different from the resonance frequency are known in the art. See, e.g., international applications PCT/IL2010/000759 and PCT/IL2011/000341 and U.S. application Ser. No. 12/497,088, the disclosures of which applications are hereby disclosed in their entirety.

In loosely coupled mode, the system 100 may be configured for the primary and secondary inductors to allow inductive power transfer over longer ranges, rather than over a short range that may require a degree of specificity in the relative positions, e.g., alignment between the primary and secondary inductors. In one aspect of the loosely coupled configuration, the resonance frequency of the system 100 is adjusted to match the driving frequency of the voltage in the primary inductor 220. A primary inductor with a driving voltage oscillating at a certain frequency tend to couple with a secondary inductor whose resonant frequency matches with the frequency of the oscillating driving voltage, while weakly interacting with other objects having non-matching resonant frequencies. Weak interactions with said other objects also reduce the dissipation of power from the inductive power transmitter into unwanted targets.

According to various multi-mode inductive power transfer systems 100, the mode selector 324 may be activated manually or automatically. Optionally, an automatic mode trigger mechanism 3050 may be provided to monitor the relative positions of the inductive power transmitter 200 and the inductive battery 300 and to select coupling mode as appropriate. Such a mode trigger 3050 may include sensors such as position sensors 3052, proximity sensors 3054 or the like.

### Inductive Battery

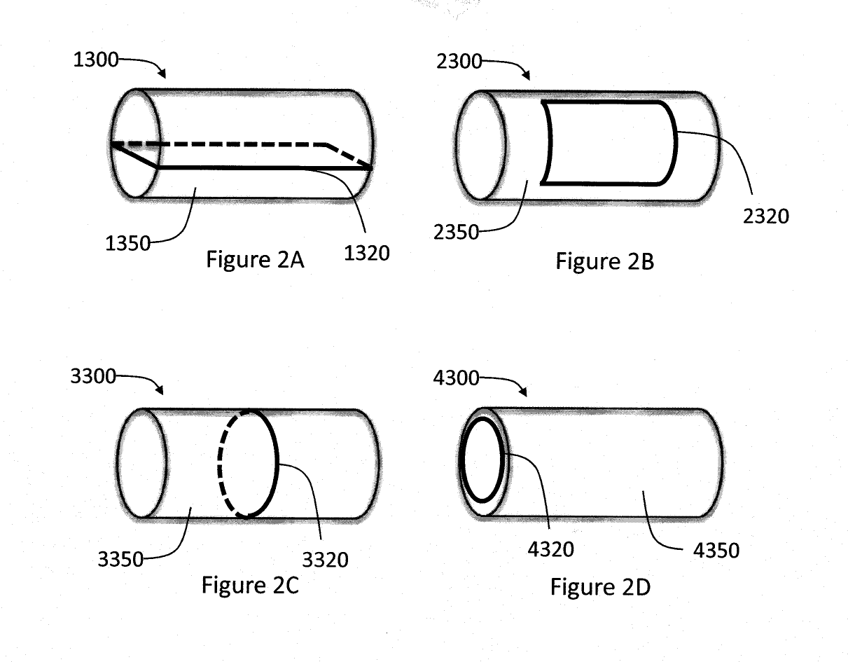

In reference to FIGS. 2A-D, schematic representations of illustrative examples an inductive battery 300 with the secondary inductor 322 are shown. For the purposes of illustration only, FIGS. 2A-D show cylindrically shaped inductive batteries 1300, 2300, 3300, 4300. As discussed below, the inductive battery 1300, 2300, 3300, 4300 may be in the shape of an industry standard battery. The inductive battery 1300, 2300, 3300, 4300 includes a secondary inductor 1320, 2320, 3320, 4320 which may be wired to an electric load 340 via a reception circuit 310 (FIG. 1). The inductive battery 1300, 2300, 3300, 4300 may further include a battery case 1350, 2350, 3350, 4350 that contains the electric load and a battery cover such as a sticker, sheath, film, paint, envelope, laminate layer or the like that surrounds the battery case 1350, 2350, 3350, 4350. The reception circuit 310 (FIG. 1) and the automatic mode trigger mechanism 3050 (FIG. 1) may also be situated in the interior space of the battery case 1350, 2350, 3350, 4350. Alternatively, one or both of the reception circuit 310 and the automatic mode trigger mechanism 3050 may be situated between the battery case 1350, 2350, 3350, 4350 and the battery cover. The secondary inductor 1320, 2320, 3320, 4320 may be situated between battery case 1350, 2350, 3350, 4350 and the battery cover.

The secondary inductor 1320, 2320, 3320, 4320 may be configured to be in any orientation as appropriate, e.g., as shown in FIGS. 2A, 2B, 2C and 2D. As shown in FIGS. 2A and 2C, the secondary inductor 1320,3320 may be a coil of conducting wire that is wrapped around the exterior of the battery case 1350, 3350. As shown in FIGS. 2B and 2D, the secondary inductor 2320, 4320 may be situated along the surface of the battery case 2350, 4350. In still other embodiments, an inductive power receiver 300 (FIG. 1) may comprise a plurality of secondary inductors arranged in a plurality of configurations, orientations and positions.

Referring back to FIG. 1, the inductive battery 300 comprises at least one secondary inductor 320 connectable to a regulator 330 and an electric load 340. The electric load 340 may be a power pack, e.g., an electrochemical cell, battery or a supercapacitor. The secondary inductor 320 is configured to couple inductively with at least one primary inductor of the inductive power transmitter 200 such that power is transferred to charge the power cell. Further, the electric load 340 may be shielded to protect it from undesirable eddy currents within its conductive components.

According to various embodiments, the dimensions of the inductive battery 300, and characteristics of the power pack 340 are selected to be connectable or incorporated into a variety of electrical devices such as a remote control unit, a telephone, a media player, a game console, a personal digital assistant (PDA), a Walkman, a portable music player, a dictaphone, a portable DVD player, a mobile communications device, a calculator, a mobile phone, a hairdryer, a shaver, a defoliator, a delapidator, a wax-melting equipment, a hair curler, a beard trimmer, a light, a radio, an electric knife, a cassette player, a CD player and the like. Embodiments of the inductive power receiver may thereby provide inductive charging functionality to existing electrical devices with no modification of the electrical device itself.

Because the lifetime of an electrochemical cell may be shorter than the lifetime of the electrical device to which it provides power, electrical devices are typically designed such that their power packs are easily replaceable. The inductive power receiver 300 disclosed herein make use of this replaceablity by providing a battery, such as a lithium-ion electrochemical cell for example, configured to supply power at the voltage required to provide power to the associated electrical device. Suitable electrochemical cells include, for example, lithium-thionyl chloride cells or its variants such as the high energy density Li/SOCl2 Cells, Li/SO2 Cells, Li/MnO2 Cells, Lithium Polymber Cells, Special Cells, Mobile Phone Cells, Charger Li-ion Cells, NiMH Cells, New Products NiCd Cells or the like.

As such, the inductive power receiver 300 may be in a shape that is substantially the same as, and compatible with, typical connection mechanisms for, industry standard battery shapes, for example, but not limited to: AAA (alternatively U16, Micro, Microlight, MN2400, MX2400, Type 286, UM 4, #7 or 6135-99-117-3143), AA (alternatively U7, Pencil sized, Penlight, Mignon, MN1500, MX1500, Type 316, UM3, #5, 6135-99-052-0009 or 6135-99-195-6708), C (U11, MN1400, MX1400, Baby, Type 343, BA-42, UM2, #2, 6135-99-199-4779 or 6135-99-117-3212), D (alternatively U2, Flashlight Battery, MN1300, MX1300, Mono, Type 373, BA-30, UM1, #1, 6135-9-464-1938 or 6135-99-109-9428), 9-Volt (alternatively PP3, Radio Battery, Smoke Alarm, MN1604, Square Battery, Krona, Transistor or 6135-99-634-8080), and Watch Cell (alternatively Button Cell, Coin Cell, Micro Cell or Miniature Cell).

### Tuning of Resonance

The strength of an induced voltage in the secondary inductor of an inductive couple varies with the oscillating frequency of the electrical potential provided to the primary inductor. The induced voltage is strongest when the oscillating frequency is at the resonant frequency of the system. The resonant frequency of the system depends upon the inductance L and the capacitance C of the system. The value of the inductance L and the capacitance C of the system are themselves dependent upon a number of parameters such as the inductance of the primary inductor, inductance of the secondary inductor, the distance therebetween, the geometry of the system, the mutual inductance, the capactitance of reception and transmission circuits and the like. As some of these parameters are likely to be variable in inductive transfer system, determination and tuning of the natural resonant frequency may be desirable.

Accordingly, referring back to FIG. 1, the inductive battery 300 may be provided with at least one resonance tuner 322. The battery-side resonance tuner 322 may include a variable capacitor or bank of capacitors selectively connectable to the reception circuit so as to vary the resonant frequency. Alternatively, or additionally, a battery-side resonance tuner 322 may include a variable inductor or bank of inductors selectively connectable to the reception circuit 310 so as to vary the resonant frequency f_{R}. The target frequency to which the resonant frequency f_{R} is adjusted may depend on the operational mode, e.g., a tight coupling mode or a loose coupling mode, which is set by the mode selector 324.

### Modes of Operation

In some embodiments, in tight coupling mode, the resonance tuner may adjust the resonant frequency such that it is substantially different from the driving frequency set by the driver 230. The target frequency range for the resonant frequency may be determined by multiplying the driving frequency set by the driver 230 by a scaling factor. Accordingly, in certain embodiments, the resonant frequency may be adjusted such that the driving frequency is between say 50-90% of the resonant frequency f_{R} or alternatively between 110-160% of the resonant frequency of the system, or some other such defined range.

In loose coupling mode, the resonance tuner may adjust the resonant frequency such that it is the same as the driving frequency set by the driver 230.

The construction of resonance tuners is well known in the art. Various frequency modulation units may be incorporated into the system in order to adjust the natural frequency, discretely or continuously, in order to regulate the power provided to the electric load. For example, various inductance altering elements and capacitance altering elements are described in the applicants' copending applications U.S. Ser. No. 61/566,103, PCT/IL2010/000759 and PCT/IL2011/000341, each of which are incorporated herein by reference in its entirety. It is to be understood that other frequency modulation units may be alternatively used to suit requirements.

### Resonance Seeking Arrangement

It is a feature of inductive power transfer that it may be configured to transmit power at the resonant frequency of the inductive couple, or at a frequency that is substantially different from the resonant frequency, as adjusted by a scaling factor. Thus, it is useful to know the resonant frequency of the system. After determining the resonant frequency, tuning mechanisms may then be employed to tune the resonant frequency in order to maintain optimal power transmission.

The resonant frequency of an inductive power system 100 is determined by the components of the inductive power transmitter and the inductive power receiver. A single inductive power transmitter may be coupled to a number of individual inductive power receivers, and the prediction of the natural resonant frequency of the coupling during manufacture of the inductive power outlet may be impractical, or unduly limiting. Moreover, the natural resonant frequency of an inductive coupling may not be stable, and the system characteristics of the inductive power transfer system, possibly the inductive power receiver, the inductive power transmitter or both may fluctuate over time. Thus, over the lifetime of the system, the natural frequency of the system may vary.

For at least these reasons, other embodiments of the inductive power transfer system may comprise resonance-seeking arrangements configured to determine the natural resonance frequencies of the inductive power transfer system before and/or during operation. Once the natural resonance frequency of the system is determined, the resonance characteristics of an inductive power receiver may be tuned, as discussed above, such that the resonance frequency matches, or is substantially different from, the driving frequency of the inductive power transmitter.

Resonance seeking arrangements are well known in the art. See, e.g., international application PCT/IL2011/000341, the disclosure of which is incorporated herein in its entirety.

### Induced Secondary Voltage Output

Electric loads such as electrochemical cells, batteries and supercapacitors are sensitive to heat and overcurrent and overvoltage conditions. Care is needed, when charging an electric load, to follow a charging protocol, which is typically selected to suit the chemistry of said electric load. Sophisticated electronic circuitry is often provided to control the power transfer, generate DC current/voltage, monitor and protect the electrochemical cell, and optimize its charging.

Referring back to FIG. 1, it is a particular feature of embodiments of the regulator 330 that it may be operable to provide power to the electric load 340, for example charging the power pack. Accordingly, in various embodiments, the regulator 330 may be configured to perform a variety of functions including, but not limited by, the following:
rectification of alternating current (AC) generated by the secondary inductor 320 into direct current (DC) for charging the power pack 340,
monitoring and regulating the charging voltage across the power pack 340,
monitoring and regulating the charging current to the power pack 340,
monitoring and regulating the temperature of the power pack 340, for example, by controlling the charging current,
monitoring and regulating the energy transfer to the secondary inductor 320 from the primary inductor 220,
indicating that the power pack 300 is fully charged, possibly via a charge indication light,
monitoring charge status,
monitoring voltage across the power pack 340,
automatically terminating the charging process when the power pack 340 is fully charged,
detecting faults,
prevention of deep discharge of the power pack, and
synchronization/communication with the battery pack electronics.

Referring again to FIG. 1, a block diagram is shown representing selected components of the inductive power transmission system 100. It is a particular feature that the regulation of power transfer, specifically the induced secondary voltage generated by the secondary inductor, may be controlled, at least in part, by a regulator 330 in the inductive power receiver 300.

It is noted that an induced secondary voltage across the secondary inductor 320 produces an alternating current (AC). Where the electric load 340 requires direct current (DC), such as for charging electrochemical cells, a rectification circuit is provided to convert AC to DC. Where AC output is required, an inverter, an AC-AC converter or the like (not shown) may be provided.

The receiver-side regulator 330 is configured to directly monitor the output voltage produced by the secondary inductor 320 and to compare the monitored output value with the operating voltage required by the electric load 340. The regulator 330 is further configured to bring the monitored output voltage closer to the required operating voltage of the electric load 340 by adjusting the resonance frequency of the inductive transmission system 100. Optionally the regulator 330 may be further configured to monitor additional operating parameters, such as temperature, current and the like.

The receiver-side regulator 330 may comprise, for example, a comparator, a switching unit and/or a resonance-altering component. The comparator is typically configured to compare the monitored output voltage Vₒᵤₜ with a reference voltage V_{ref} having a value indicating the required operating voltage of the electric load. The switching unit is typically configured to connect the resonance-altering component to the power reception circuit when the difference between the monitored output voltage Vₒᵤₜ and the reference voltage V_{ref} exceeds a threshold value. Methods and compositions for regulating output voltage from a secondary inductor are well known in the art.

Further embodiments may include elements for reducing the output voltage Vₒᵤₜ if it rises above the required operating voltage V_{req}. Such voltage reducing elements may include resonance decreasing elements or alternatively switching units for intermittently disconnecting the electric load from the output voltage altogether.

### Trickle Charging

Further embodiments may include elements for enabling trickle charging of the electric load 340 such as the charging of a capacitor, a power pack, electrochemical cell, battery or the like. In trickle charging for a load such an electrochemical cell or a battery, a relatively low current is used to charge the electric load 340, typically at a rate similar to the self-discharging rate of the electric load 340, thus maintaining full capacity of the electric load 340. The regulator 330 may be configured for trickle charging of the power pack or electric load 340. Optionally, the receiver side regulator 330 monitors the discharge voltage of the electric load 340. If the electric load discharge voltage is at a reference level signifying full charge, the switching unit may disconnect the electric load 340 from the induced output voltage. If the electric load discharge voltage falls below the reference level, the switching unit may connect the electric load 340 to the induced output voltage, thus resuming charging.

It is noted that over-charging may be damaging for many electrochemical cells. Therefore charging of the electric load 340 may be automatically terminated when the target voltage has been reached or the charging current has dropped below a predetermined level.

Because excessive current can damage the electric load 340 and may be indicative of a short circuit or other fault, the regulator 330 may be configured to monitor charge or discharge current. Accordingly, the regulator 330 may further include a current limiter for reducing or cutting-off large currents in excess of the rated charge current, for example currents above 1.2 ampere or so, which may be damaging to the battery. Current monitoring and limiting functionality may be provided by means of a current sense resistor. It is further noted that, in embodiments in which a protection circuit disconnects the power pack when fully charged, the interface module may be further configured to ensure that the power pack is fully charged by periodically reactivating the charge current. Where required, a periodic refresh charging procedure may be activated after set intervals of, say, two hours or so, although longer or shorter intervals maybe used as appropriate.

### Temperature

It is noted that the charging process may be temperature dependent. High charging temperatures may damage an electrochemical cell and low temperatures may result in limited charging. Because of this temperature dependency, the interface circuit 100 may be further configured to monitor and regulate the power pack temperature during the charging. Optionally, a temperature sensor, such as a thermometer, thermistor, thermocouple, digital sensor apparatus or the like, may be provided to monitor charging temperature and logic applied to limit charging current in order to keep the operating temperature within a required range. Notably, particular embodiments may be configured to operate within the internal temperature range from say minus ten degrees Celsius to forty-five degrees Celsius (263 Kelvin to 328 Kelvin), although other operating temperature ranges may be selected where required.

Where required, indicators may be provided in the inductive power receiver 300 for indicating such states as excessive charge current, low charge current, excessive temperature, absence of electric load, battery charging state, a fully charged power pack, fault conditions and the like.

### Small and Low Profile

In addition, various features of the system may be directed towards allowing the control components to have smaller size. Embodiments described herein provide a simplified, smart, low cost and low profile electronic system for inductive charging of the power pack as well as an inductively enabled power pack.

It is a particular feature of the inductive power receiver 300 that that the reception circuit 310, or components thereof, may be incorporated into a printed circuit. The reception circuit may be printed directed onto the inductive power receiver 300, or printed onto a separate medium, e.g., a thin film and attached to the inductive power receiver 300 by an adhesive, pressure clip or the like.

It is a particular feature of the inductive power receiver 300 that the reception circuit 310, or components thereof, may be incorporated into an integrated circuit (IC) configured to perform a plurality of control functions. It is noted that, in order to avoid compromising the size of a power pack, the dimensions of the reception circuit 310 may be minimized. Therefore, according to selected embodiments, the reception circuit 310 may be an IC. In certain embodiments, the regulator 300 may be incorporated into an Application-Specific Integrated Circuit (ASIC). ASICs may be preferred to other ICs as they generally have very small dimensions. In particular embodiments, a plurality of components of the reception circuit 310 can be assembled into one Multi Chip Module (MCM) or implemented in a Monolithic IC. In particular embodiments, all the components of the reception circuit 310 can be assembled into one Multi Chip Module (MCM) or implemented in a Monolithic IC.

A particular limitation upon the size of electrical components is the rate at which they can dissipate heat. Smaller components do not dissipate heat as well as larger components. Selected embodiments of the system reduce the heat generated by the control components so that they may be of smaller dimensions.

A first heat reduction feature enabling small control components is that inductive transmission of power through loose coupling results in lower transmission voltages than tight coupling. Thus, configuring the inductive power transmitter and/or the inductive power transmitter to couple loosely may result in less heat being generated by control components and they may therefore have smaller dimensions.

In a second heat reduction feature, the embodiments may include elements for enabling trickle charging of the electric load 340. In trickle charging for an electric load such an electrochemical cell or a battery, a relatively low current is used to charge the electric load, typically at a similar rate as the self-discharging rate of the electric load, thus maintaining full capacity of the electric load.

A third heat reduction feature enabling small control components, which is used in other embodiments of the power pack, is that in some embodiments a low heat loss rectifier may be used to convert AC power from the secondary inductor 320 to DC power to charge the electrochemical cell 340. Rather than using a bridge rectifier, in which four diodes are arranged in a Graetz circuit, a bridge synchronous rectifier may be used, such as that described in co-pending U.S. patent application Ser. No. 12/423,530, which is incorporated herein by reference. In the synchrorectifier, at least one of the four diodes of a typical Graetz circuit is replaced by a current-triggered electronic switch. For example a Power MOSFET may be configured to receive a gate signal from a current monitor wired to its own drain terminal. The current monitor may be configured to send a gate signal to the MOSFET when the drain-current exceeds a predetermined threshold.

Because the MOSFETs of the synchorectifier described above produce less heat than diodes, heat dissipation becomes easier even for high power or high frequency power transmission. Consequently, a rectifier with a smaller footprint may be included in the regulator 330, allowing it to be more easily contained within the inductive power receiver 300.

### Battery Case as Inductive Power Transmitter

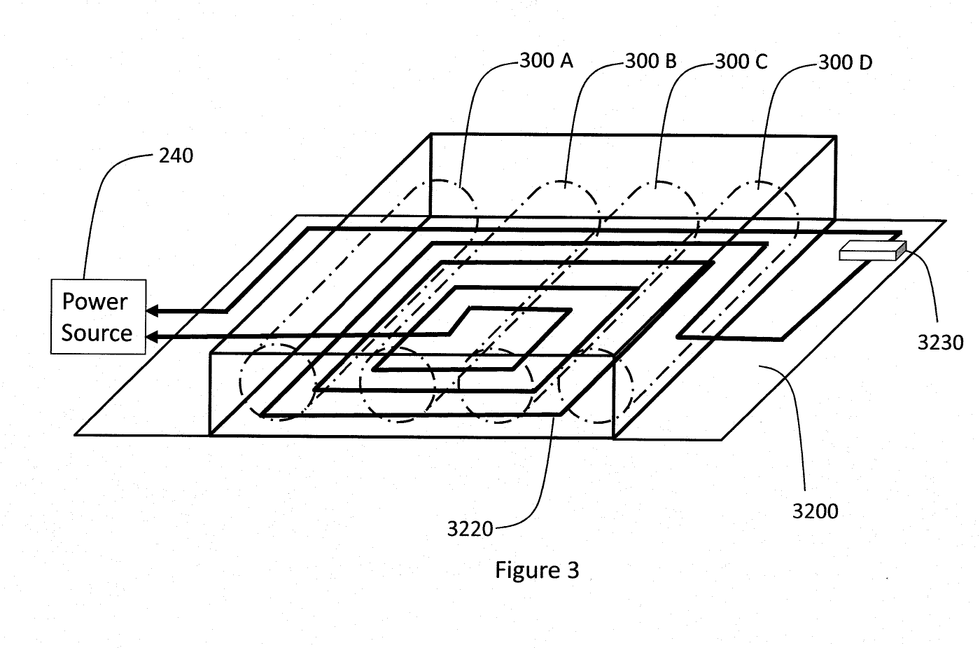

Referring to FIGS. 3-6, the inductive power transmitter 3200, 4200, 5200, 6200 may be configured as a battery case. The inductive power transmitter 3200, 4200, 5200, 6200 may be in the shape of a container that is capable of holding one or more inductive power receivers. Preferably, the case is capable of alternating between an open and closed arrangement, e.g., with a lid (not shown).

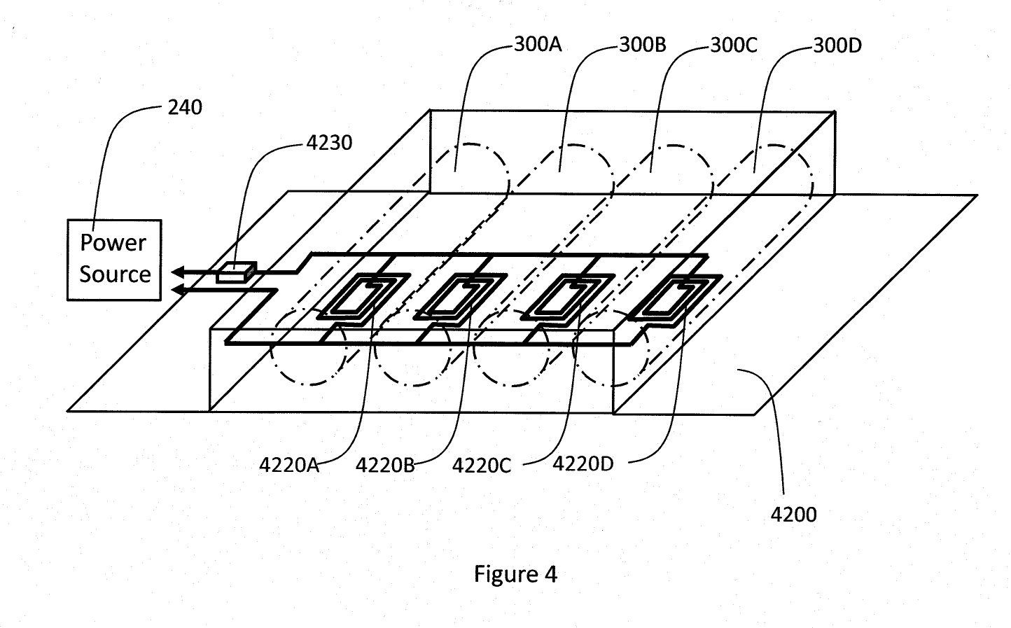

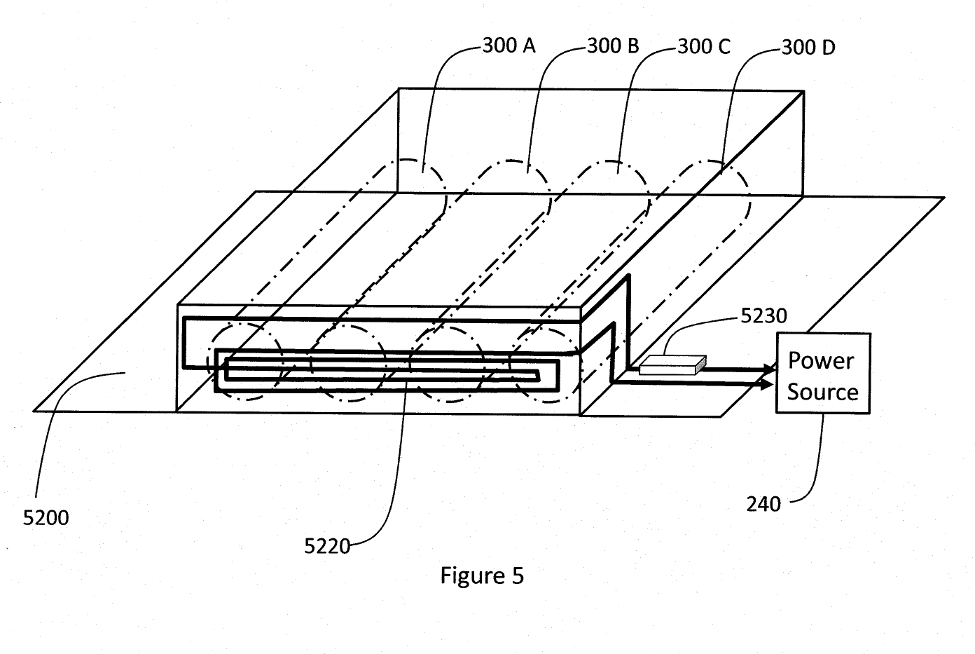

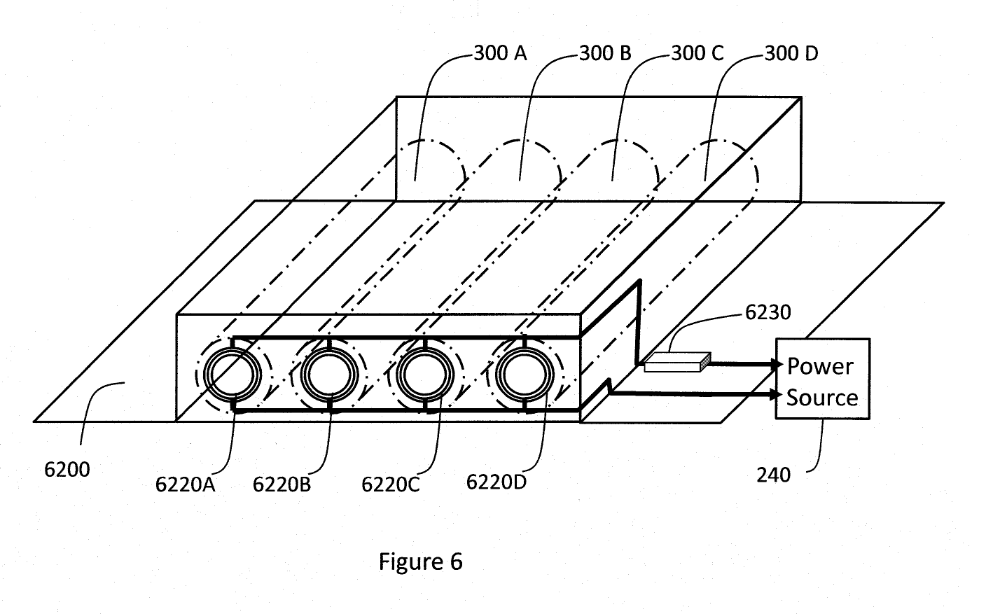

The inductive power transmitter 3200, 4200, 5200, 6200 may comprise one or more primary inductors 3220, 4220A-D, 5220, 6220A-D incorporated within it. The multiple primary inductors may be configured in the inductive power transmitter in different orientations and/or positions. The inductive power transmitter 3200, 4200, 5200, 6200 may include one primary inductor 3220, 4220A-D, 5220, 6220A-D that is connected to a power source 240 via a driver 3230, 4230, 5230, 6230 and operable to inductively couple with at least one secondary inductor 330 associated with one or more inductive batteries 300. See, e.g., FIGS. 3 and 5. Alternatively, the inductive power transmitter 3200, 4200, 5200, 6200 may include multiple primary inductors 3220, 4220A-D, 5220, 6220A-D, with each primary inductor configured to inductively couple with one secondary inductor 320. See, e.g., FIGS. 4 and 6. The primary inductor 3220, 4220A-D, 5220, 6220A-D may be covered by an insulating cover (not shown) to protect it from damage and undesired electrical contact with other components of the inductive battery or any other conductive objects.

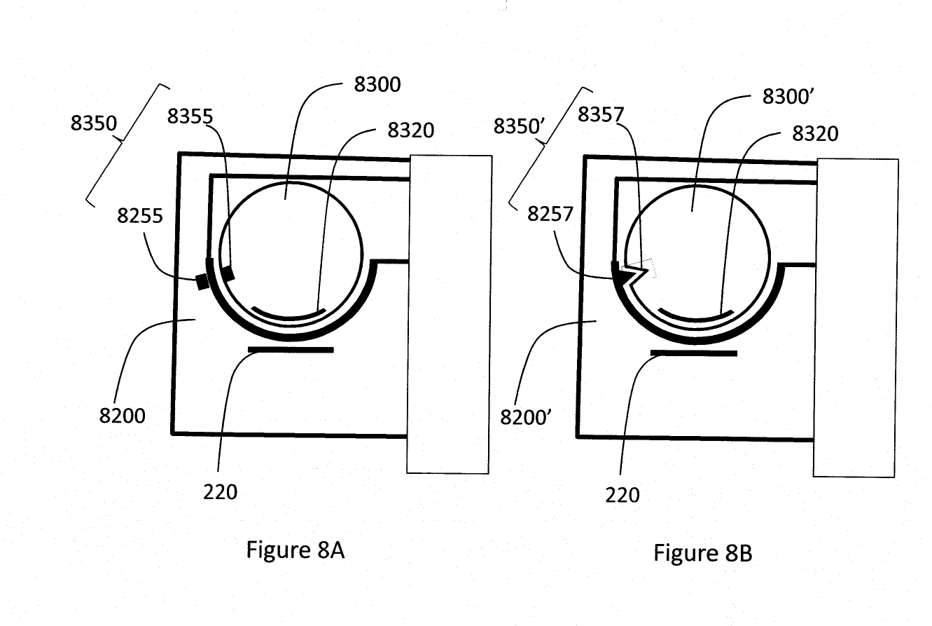

Further referring to FIGS. 5 and 6, in embodiments of the system 100 where inductive battery 300 is cylindrically shaped, e.g., an AA shape, it may be advantageous to have a secondary inductor (not shown) situated on one of the circular faces and concentric to the central axis, e.g., as shown in FIG. 2C or 2D, such that the level of alignment between the secondary inductor and the corresponding primary inductor is unaffected by the rotational position of the inductive battery 300. However, the rotational position of a cylindrical inductive battery 300 may be fixed by various alignment mechanisms, as discussed below and exemplified in FIGS. 8A and 8B.

### Alignment of Primary and Secondary Inductors

The efficiency of the power coupling 100, particularly for tight coupling, is highly dependent on the proper alignment between the secondary inductor 320 and the primary inductor 220.

The proper alignment between the secondary inductor 320 the primary inductor 220 may be enabled, fully or in part, by the inductive power transmitter 200 having compartments that are fitted for the individual inductive batteries 300, thus preventing movement of the encased inductive batteries 300. The inductive battery 300 immobilized with the fitted compartment(s) of the inductive power transmitter, in combination with having the primary inductor 220 situated in a set arrangement in the inductive power transmitter 200 and having the secondary inductor 320 situated in a specific way on the inductive battery, may provide proper alignment between the secondary inductor 320 and the primary inductor 220.

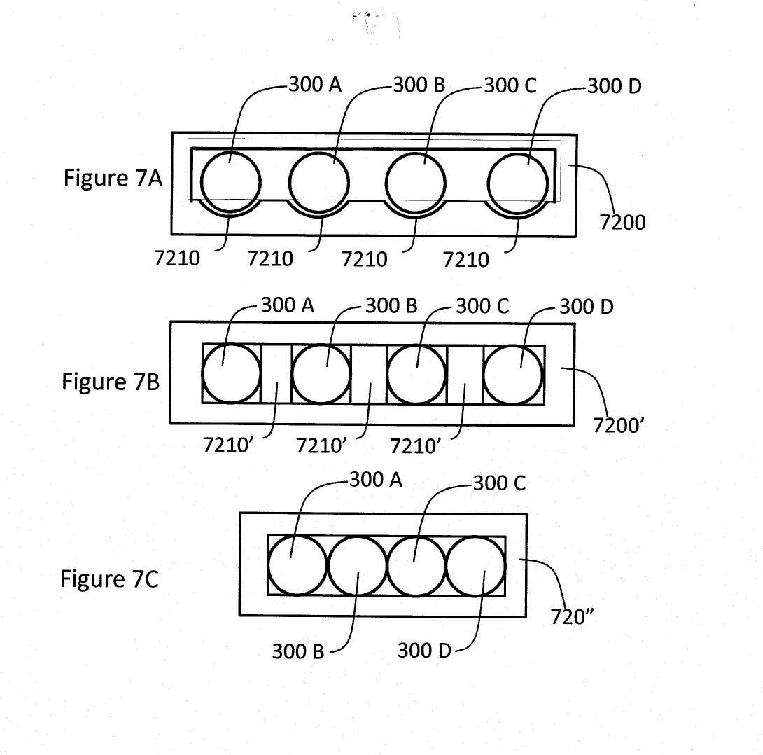

Referring now to FIGS. 7A-C various examples are shown of inductive power transmitters 7200, 7200′, 7200″ that are shaped to create compartments that are fitted for multiple inductive batteries 300 and preventing movement of said inductive batteries 300. For the purposes of illustration only, FIGS. 7A-C show inductive power transmitters shaped to fit four cylindrically shaped inductive batteries 300. The inductive battery 300 may be in the shape of an industry standard battery as discussed above, and the inductive power transmitter may incorporate position guiding elements provided to urge a battery into a desired position within the transmitter casing. For example, a position guiding element may be provided by shaping the casing to fit one, or any number, of inductive batteries.

FIG. 7A shows an inductive power transmitter comprising a first example of a position guiding element 7210 wherein indentations or grooves are provided matching the shape of an inductive battery 300. As shown in FIG. 7B, in another embodiment, a second position guiding element 7210′ may include spacers provided to form therebetween compartments within the inductive power transmitter 7200 for securing the batteries in the required positions. As shown in FIG. 7C, in another embodiment, the inductive power transmitter 7200 may be one compartment that is of a shape and size such that it precisely fits a predetermined number of inductive batteries 300.

In the case where the inductive battery is of a shape that has no circular cross-sections and no rotational motion is possible in a fitted compartment, e.g., a 9-volt battery that is rectangular in shape, the shape of the inductive power transmitter 200 fitting the inductive battery 300 may be sufficient to completely prevent movement and ensure that the primary inductor 220 and the secondary inductor 320 remain aligned.

In embodiments where rotation of the inductive battery may impede energy transfer or is otherwise undesirable, for example, in the case where the inductive battery is cylindrically shaped and capable of rotational motion in a fitted compartment, the inductive power transmitter 200 and inductive battery 300 may comprise a rotational alignment mechanism.

With reference to FIG. 8A, a first rotational alignment 8350 mechanism may include a magnetic anchor 8255 situated on the inductive power transmitter 8200 and a magnetic snag 8355 situated on the inductive battery 8300, wherein the magnetic snag 8355 is configured to engage with the magnetic anchor 8255 when the secondary inductor 8320 is optimally aligned to the primary inductor 8220. The magnetic snag 8355 and the magnetic anchor 8255 may run along the length of the inductive battery 8300 and the inductive power transmitter 8200, respectively. Alternatively, the magnetic snag 8355 and the magnetic wedge may run along a portion of the length of the inductive battery 8300. Alternatively or in combination, the magnetic snag 8355 and magnetic anchor 8255 may be situated on the circular surface of the inductive battery 8300. Variously, the magnetic snag may be selected from the group comprising at least one permanent magnet, at least one electromagnet and at least one ferromagnetic element. Accordingly, the magnetic anchor may be selected from the group comprising at least one permanent magnet, at least one electromagnet and at least one ferromagnetic element. It will be appreciated that the attraction between the magnetic anchor and the magnetic snag may be strong enough to remain engaged in the face of moderate jostling, yet weak enough that a user may engage and disengage the alignment mechanism as needed by hand. For magnetic coupling, it will be appreciated that a permanent or electro magnet in the casing may exert an attractive force on a second permanent or electromagnet on the battery. Alternatively, the battery may be fitted with a piece of ferrous material that is attracted to a magnet but is not itself, magnetic. Furthermore, the casing may include a piece of iron that is attracted to a magnet, and the battery may be provided with a permanent or electro-magnet. A preferred magnetic alignment configuration is a permanent magnetic snag configured to couple with a permanent magnetic anchor. The orientations of the magnetic snag and the magnetic anchor are such that facing ends have opposite polarity so that they are mutually attractive.

With reference to FIG. 8B, the rotational alignment mechanism 8350′ may be a groove 8357 on the inductive battery 8300′ and a notch or wedge 8257 situated on the inductive power transmitter 8200′, wherein the wedge 8257 is configured to be caught inside the groove 8357 when the secondary inductor 8320′ is optimally aligned to the primary inductor 8220′. The groove 8357 and the notch 8257 may run along the length of the inductive battery 8300′ and the inductive power transmitter 8200′, respectively. Alternatively, the groove 8357 and the notch 8257 may run along a portion of the length of the inductive battery 8300′. Alternatively or in combination, the groove 8357 and notch 8257 may be situation on the circular surface of the inductive battery 8300′. It will be appreciated that the cross-sectional shape of the groove 8357 and notch 8257 may be another shape, such as a rectangular shape or a rounded shape, or the like, provided that the notch 8257 fits snugly into the groove 8357 such that rotational movement is prevented. Alternatively, the inductive battery 8300′ may comprise a notch and the inductive power transmitter 8200′ may comprise a groove.

Each inductive battery 8300′ and the corresponding compartment in the inductive power transmitter 8200′ may comprise multiple magnetic snag/anchor pairs or multiple wedge/groove pairs. Further, each inductive battery 8300′ and the corresponding compartment in the inductive power transmitter 8200′ may comprise multiple types of rotational alignment mechanism, e.g., a magnetic snag/anchor pair in combination with a wedge/groove pair.

The system may comprise further alignment mechanisms, as described below.

### Mechanical Alignment Mechanisms

A tactile alignment mechanism for an inductive power transmitter 200 may be a central magnetic snag surrounded by the primary inductor 220 with the corresponding inductive battery 300 including a central magnetic anchor surrounded by the annular secondary coil 320.

The central magnetic snag is configured to engage with the magnetic anchor carried by the inductive power transmitter 200, when the secondary inductor 320 is optimally aligned to the primary inductor 220. The anchor-snag arrangement, once engaged, serves to lock the inductive battery 300 into alignment with the inductive power transmitter 200. It will be appreciated that the attraction between the magnetic anchor and the magnetic snag may be strong enough to remain engaged in the face of moderate jostling, yet weak enough that a user may engage and disengage the alignment mechanism as needed by hand.

It will also be appreciated that, in an embodiment wherein the secondary inductor 320 is situated on the circular face of the inductive battery 300 (see, e.g., FIG. 2D) and the inductive power transmitter comprises a corresponding primary inductor 220 (see, e.g., FIG. 6), the combination of a central circular magnetic snag on the inductive battery 300 concentric to the secondary inductor 320 with a central circular magnetic anchor in the inductive power transmitter allows the inductive battery 300 to rotate around a central axis without losing alignment.

### Visual Alignment Mechanisms

An inductive battery 300 may comprise a mark indicating the location of a secondary inductor 320, and an inductive power transmitter 200 may comprise a mark indicating the location of a primary inductor 220. The markings enable the user to orient the inductive battery 300 in relation to the inductive power transmitter 200 so that the secondary inductor 320 will be aligned with the primary inductor 220.

Alternatively or in combination, the alignment of the primary and secondary inductors may be indicated by LEDs. The alignment system may consist of consisting of two indicator LEDs: a rough proximity indicating orange LED and proper alignment indicating green LED. It will be appreciated that a larger number of LEDs provides for a greater degree of graduation in indication of proximity, and helps the user home in on the concealed jack. An LCD display may provide an alternative visual indicator, which can, in addition to providing indication of the degree of alignment, also provide indication of the current drawn by the electric load coupled to the plug, for example.

By their nature, LEDs are either illuminated or not illuminated. However proximity data may be encoded by flashing, frequency or the like. The intensity of power supplied to other types of indicator lamps may be used to indicate the degree of coupling, or a flashing indicator lamp may be provided, such that the frequency of flashing is indicative of degree of alignment.

### Audible Alignment Mechanisms

Non-visual alignment means may alternatively or additionally be provided. For example, an audible signal may assist the visually impaired attain alignment. The inductive power transmitter 200 may comprise a buzzer that is configured to provide an indication of proximity to alignment for example by variation in tone, pitch, volume, timbre, beep frequency or the like. Alternatively, the buzzer may be configured to buzz in a manner indicating whether there is alignment.

### Multiple Inductive Power Transmitters Powered by a Single Power Source

As noted above, an inductive power transmitter 200 may be connected to a power source 240 such as a mains electricity socket, a transformer, a power pack, solar panel or the like. In certain embodiments, the inductive power transmitter 200 may be connected to a second electronic device that is itself connected to a power source, e.g., if the inductive power transmitter 200 is connected to a USB port for example of a computer through a USB cable and the USB port is itself connected to, and powered by, an electricity socket or another power pack. In certain embodiments, the second electronic device is another inductive power transmitter 200. In other embodiments, the second electronic device is a storage apparatus 260, for example, a shelf, a box, a table and the like.

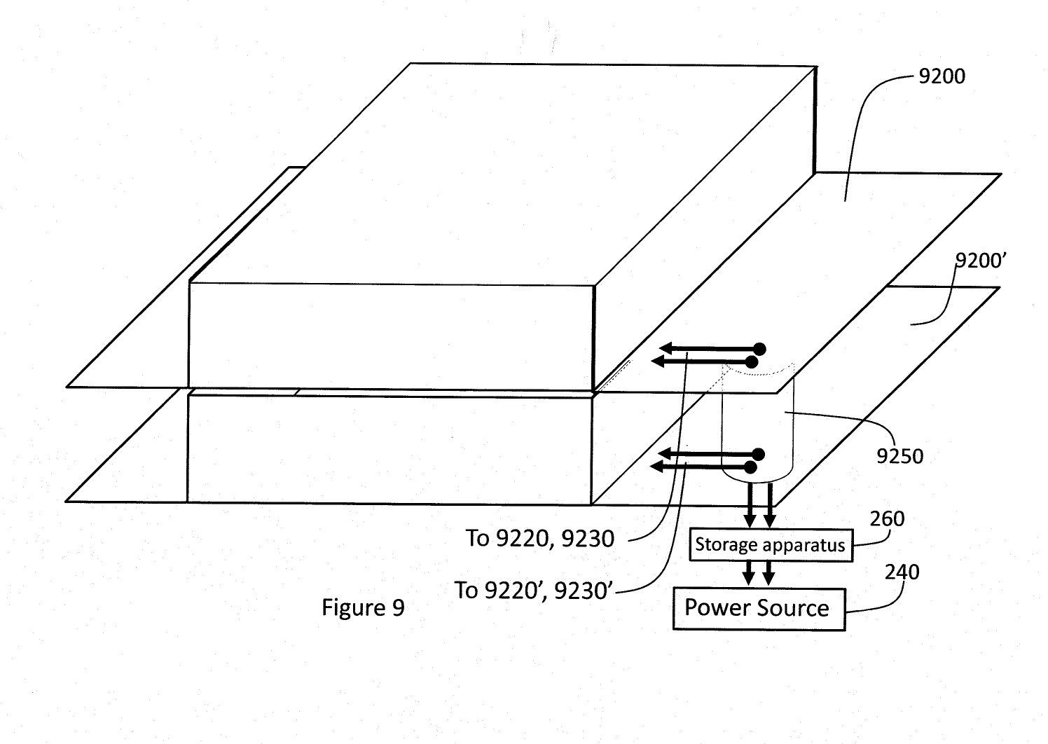

In reference to FIG. 9, a plurality of inductive power transmitters 9200 may be connected to one power source 240. The inductive power transmitters may be configured such that they are electrically connected when stacked together. The inductive power transmitter 9200 may comprise a connector 9250 that facilitates electric connection between inductive power transmitters, e.g., between inductive power transmitters 9200 and 9200′. Further, the stack of electrically connected inductive power transmitters may be placed on (or inserted into) a storage apparatus 9260 such that the inductive power transmitters are connected to a power source 240. In certain embodiments, the inductive batteries (not shown) in the inductive power transmitters 9200 and connected to the storage apparatus 9260 are fully charged, and being charged via trickle charging. As discussed above, during trickle charging, a relatively low current is used to charge the battery, typically at a similar rate as the self-discharging rate, thus maintaining full capacity of the battery. Further, if the discharge voltage of the battery is at a reference level signifying full charge, the switching unit may disconnect the battery from the charging voltage. If the discharge voltage of the electric load falls below the reference level, the switching unit may connect the electric load to the induced output voltage, thus resuming charging. Further, the storage apparatus 8260 may be configured to connect the power source 240 to the inductive power transmitters 200 periodically.

### Method of Determining Operational Mode

Referring back to FIG. 1, in certain embodiments, the inductive battery 300 may be enabled to operate in a tightly coupled mode, e.g. by the resonance tuner 322 setting the resonant frequency of the system to be substantially different from the driving frequency of the voltage across the primary inductor 220. In other embodiments, the inductive battery 300 may be enabled to operate in a loosely coupled mode, e.g. by the resonance tuner 322 setting the resonant frequency of the system to be the same as the driving frequency of the voltage across the primary inductor 220. In other embodiments, the operational mode of the inductive battery 300 may be toggled manually. In a preferred embodiment, the inductive battery 300 may be enabled to operate in multiple modes, e.g., tightly coupled mode and loosely coupled mode, and further be capable of automatically switching between the modes as appropriate.

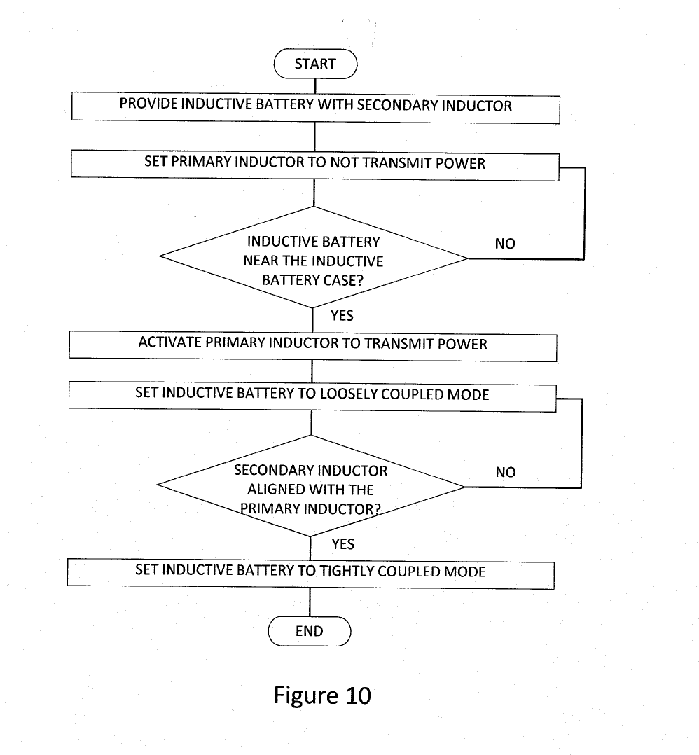

Referring now to the flowchart of FIG. 10, a method is represented for determining the operational mode of the system 100. The method includes the steps of: providing an inductive battery comprising a secondary inductor connected to the electric load, the inductive battery being operable in at least two modes, including a tight coupling mode and a loose coupling mode—step (i); determine if the inductive battery is near a primary inductor—step (ii); if the inductive battery is near a primary inductor, then activate the primary inductor to transmit power by providing an oscillating potential difference across the primary inductor via a driving unit—step (iii); and set the inductive battery to loosely coupled mode—step (iv); determine if the secondary inductor of the inductive battery is aligned with the primary inductor—step (v); if the secondary inductor of the inductive battery is aligned with the primary inductor, then set the inductive battery to tightly couple mode—step (vi). Optionally, where no secondary inductor is detected the system may be configured to set the primary inductor not to transmit power—step (vii).

### Method for Trickle Charging During Storage

Batteries typically self-discharge at a slow rate even when they are not connected to an electronic device. As such, charge may be lost during prolonged storage of batteries. A method is taught for trickle charging inductive batteries during storage. The method includes the steps of: providing at least two inductive power transmitters, each inductive power transmitter comprising at least one primary inductor configured to couple inductively with at least one secondary inductor and at least one driver configured to provide a variable electric potential at a driving frequency across said primary inductor, and containing at least one an inductive battery comprising at least one secondary inductor connectable to a receiving circuit and an electric load, said secondary inductor configured to couple inductively with said at least one primary inductor such that power is transferred to said electric load—step (a); stacking said inductive power transmitters such that the inductive power transmitters are electrically connected—step (b); connecting the stack of inductive power transmitters to a power source—step (c). The power source may be contained within a storage device.

Alternatively a battery may be charged directly via a conductive connections to its anode and cathode terminals. In order to maintain charge in stored batteries, battery packaging may be provided having conductive charging contacts configured to conductively couple with the anode and cathode terminals of the batteries stored therein. In some embodiments, the conductive contacts may be wired to a secondary inductor incorporated in the packaging of the battery. Accordingly, when the secondary inductor of the package is inductively coupled to an external primary inductor, a charging voltage may be induced between the charging contacts of the package thereby providing a charging potential. A trickle charge may be so provided to maintain the charge level of batteries within the enabled packaging during storage.

Where required therefore, stowage facilities, such as storage shelving, boxes, cartons, warehouses and the like, may be provided with primary inductors operable to couple with secondary inductors associated such enabled battery packaging so providing a top-up charge for stored batteries. Inductive coupling may be provided between the primary inductors of the storage facility and the secondary inductors of the enabled packaging by either loose inductive coupling or tight inductive coupling as suit requirements. It is further noted that such facilities may also be used to provide a charging potential for inductively enabled batteries such as described herein.

The scope of the disclosed subject matter includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1.-31. (canceled)

32. An inductive power transfer system comprising at least one inductive battery operable to receive power from at least one inductive power transmitter,
said at least one inductive battery comprising at least one secondary inductor connectable to a receiving circuit and an electric load, said at least one secondary inductor configured to couple inductively with at least one primary inductor of said inductive power transmitter such that power is transferred to said electric load, wherein:
said electric load comprises at least one electrochemical cell;
said receiving circuit comprises a regulator operable to monitor the discharge voltage of the at least one electrochemical cell and to trickle charge the at least one electrochemical cell if the discharge voltage falls below a reference value; and
said at least one inductive battery is compatible with a connection mechanism for an industry standard battery.

33. The inductive power transfer system of claim 32, wherein said at least one electrochemical cell is selected from the group consisting of a lithium-thionyl chloride cell, a Li/SOCl2 Cell, a Li/SO2 Cell, a Li/MnO2 Cell, a Lithium Polymber Cell, a Special Cell, a Mobile Phone Cell, a Charger Li-ion Cell, a NiMH Cells and a New Products NiCd Cells.

34. The inductive power transfer system of claim 32, wherein the at least one inductive battery is compatible with connection mechanisms for, a battery shape selected from the group consisting of AAA, U16, Micro, Microlight, MN2400, MX2400, Type 286, UM 4, #7, 6135-99-117-3143, AA, U7, Pencil sized, Penlight, Mignon, MN1500, MX1500, Type 316, UM3, #5, 6135-99-052-0009, 6135-99-195-6708, C, U11, MN1400, MX1400, Baby, Type 343, BA-42, UM2, #2, 6135-99-199-4779, 6135-99-117-3212, D, U2, Flashlight Battery, MN1300, MX1300, Mono, Type 373, BA-30, UM1, #1, 6135-9-464-1938, 6135-99-109-9428, 9-Volt, PP3, Radio Battery, Smoke Alarm, MN1604, Square Battery, Krona, Transistor, 6135-99-634-8080, Watch Cell, Button Cell, Coin Cell, Micro Cell and Miniature Cell.

35. The inductive power transfer system of claim 32, wherein the electric load is shielded.

36. The inductive power transfer system of claim 32, wherein the receiving circuit comprises a resonance tuner, said resonance tuner operable to tune the resonant frequency of said receiving circuit to a plurality of target frequencies, wherein each target frequency is determined by an operational mode.

37. The inductive power transfer system of claim 36, wherein at least one of said target frequencies is selected from the group consisting of:
(a) the driving frequency of the primary inductor; and
(b) a frequency that is substantially different from the driving frequency of the primary inductor.

38. The inductive power transfer system of claim 37, wherein the driving frequency is selected from at least one of: (a) 50%-90% of the resonant frequency; and (b) 110%-160% of the resonant frequency.

39. The inductive power transfer system of claim 36, wherein the receiving circuit further comprises a resonance seeking arrangement operable to determine the natural resonant frequencies of the inductive power transfer system.

40. The inductive power transfer system of claim 36, wherein the operational mode is determined by a mode selector.

41. The inductive power transfer system of claim 40, wherein the mode selector is activated by at least one of manual activation; and automatic activation.

42. The inductive power transfer system of claim 32, wherein the regulator is configured to provide a current to the electric load such that the rate of charging the electric load is substantially the same as the self-discharging rate of the electric load.

43. The inductive power transfer system of claim 32, wherein the regulator is operable to monitor the discharge voltage of the electric load, and wherein the regulator comprises a switching unit operable to disconnect the electric load from the induced output voltage from the secondary inductor if the discharge voltage of the electric load is at a reference level signifying full charge, and further operable to connect the electric load to the induced output voltage from the secondary inductor if the discharge voltage of the electric load is below the reference level signifying full charge.

44. An inductive power transfer system comprising at least one inductive power transmitting battery case operable to transfer power to at least one inductive battery, said at least one inductive power transmitting battery case comprising at least one primary inductor configured to couple inductively with at least one secondary inductor associated with said inductive battery, and at least one driver configured to provide a variable electric potential at a driving frequency across said at least one primary inductor such that power is transferred to said secondary inductor in order to trickle charge said at least one electrochemical cell if the discharge voltage of said at least one electrochemical cell falls below a reference value.

45. The power transfer system of claim 44, wherein the inductive power transmitter provides at least one fitted compartment, each compartment capable of containing at least one inductive battery such that the inductive battery is immobilized in a position wherein the primary inductor and the secondary inductor are aligned.

46. The power transfer system of claim 44, wherein the inductive power transmitter provides a plurality of said fitted compartments, each fitted compartment being characterized by at least one feature selected from:
(a) the fitted compartment is capable of containing one said inductive battery; and
(b) the fitted compartment is configured to contain a plurality of said inductive batteries.

47. The power transfer system of claim 44, further comprising a rotational alignment mechanism.

48. A method of charging inductive batteries, comprising the steps of:
(a) providing at least two inductive power transmitters, each inductive power transmitter comprising at least one primary inductor configured to couple inductively with at least one secondary inductor and at least one driver configured to provide a variable electric potential at a driving frequency across said primary inductor, and containing at least one an inductive battery comprising at least one secondary inductor connectable to a receiving circuit comprising a regulator configured to trickle charge an electric load if the discharge voltage falls below a reference value, and said electric load comprising at least one electrochemical cell, said secondary inductor configured to couple inductively with said at least one primary inductor such that power is transferred to said electric load;
(b) stacking said inductive power transmitters such that the inductive power transmitters are electrically connected;
(c) connecting the stack of inductive power transmitters to a power source.

49. The method of claim 48, wherein the power source is contained within a storage device.

50. The method of claim 48 wherein said regulator is configured to provide a current to the electric load such that the rate of charging the electric load is substantially the same as the self-discharging rate of the load.

51. The method of claim 50, wherein the regulator is operable to monitor the discharge voltage of the electric load, and wherein the regulator comprises a switching unit operable to disconnect the electric load from the induced output voltage from the secondary inductor if the discharge voltage of the electric load is at a reference level signifying full charge, and further operable to connect the electric load to the induced output voltage from the secondary inductor if the discharge voltage of the electric load is below the reference level signifying full charge.
